(19) United States
(12) Patent Application Publication
(10) Pub. No.: US 2024/0093534 A1
(43) Pub. Date: Mar. 21, 2024

(54) DOOR-LOCKING MODULE FOR A DOOR OF A HOUSEHOLD APPLIANCE

(71) Applicant: ILLINOIS TOOL WORKS INC., GLENVIEW, IL (US)

(72) Inventors: Dino CHIRUMBOLO, Turin (IT); Bojan BICIC, Tomlin (SI); Ahsan ALI, Varese (IT); Joze LAVRENCIC, Kobarid (SI)

(73) Assignee: ILLINOIS TOOL WORKS INC., GLENVIEW, IL (US)

(21) Appl. No.: 18/367,755

(22) Filed: Sep. 13, 2023

(30) Foreign Application Priority Data
Sep. 19, 2022 (EP) 22196419.0
May 11, 2023 (EP) 23172898.1
Sep. 7, 2023 (EP) 23196093.1

(51) Int. Cl. E05B 47/00; D06F 34/20; D06F 39/14; D06F 58/20; E05B 65/00

(52) U.S. Cl. CPC E05B 47/0012; D06F 34/20; D06F 39/14; D06F 58/20; E05B 47/0011; E05B 65/00; D06F 2103/40; E05B 2047/0017; E05B 2047/002; E05B 2047/0025; E05B 2047/0036; E05B 2047/0054; E05B 2047/0068

(57) ABSTRACT

A door-locking module for a door of a household appliance includes a housing; a printed circuit board (PCB), received within the housing and further includes at least one first actuator switch adapted to open and close a predetermined first circuit of the PCB. A locking pin is configured to move between a locked position, affecting the door into a locked state, and an unlocked position, affecting the door into an unlocked state. An actuator is operably coupled to the locking pin so as to controllably move the locking pin between the unlocked position and the locked position. A locking ring is operably coupled between the actuator and the at least one first actuator switch and includes a trigger member adapted to operably engage with the signal actuator, and at least one cam guide adapted to cooperate with a corresponding cam follower of the locking pin.

### CROSS-REFERENCE TO RELATED APPLICATION

European Patent Application No. EP 22196419.0, filed 19 Sep. 2022; European Patent Application No. EP 23172898.1, filed 11 May 2023; and European Patent Application No. EP 23196093.1, filed 7 Sep. 2023; the priority documents corresponding to this invention, to which a foreign priority benefit is claimed under Title 35, United States Code, Section 119, and the entire teachings of each referenced application are incorporated, by reference, into this specification.

### BACKGROUND OF THE INVENTION

### Field of the Invention

The invention relates generally to a door-locking module. In particular, the invention relates to a door-locking module for a door of a household appliance such as a washing machine or a dryer.

### Discussion of Related Art

Door-locking modules are typically used in household appliances such as washing machines and dryers to lock the door of the appliance. For example, washing machines and/or dryers typically use a door-locking module to securely lock the door of the appliance before starting a washing or drying cycle. Further, such door-locking modules are known to prevent the door from being opened during the washing or drying cycle, as well as, prevent the washing or drying cycle from being started when the door of the appliance is open.

Existing door-locking modules contain a multitude of mechanical components which cooperate with one another to mechanically lock and unlock the door of the household appliance. Usually, an actuator is connected to a control unit of the appliance to command the movement of a locking pin between a disengaged position, in which the locking pin does not engage with the appliance door, i.e., the door is open or openable, and a locked door position, in which the locking pin engages with the appliance door, i.e., the door is locked. Other door-locking modules may have a lock switch that cooperates directly with the locking pin in order to signal to a control unit of the appliance whether the locking pin is in a locked position or an unlocked position. However, door-locking modules that can determine the position of the locking pin often have a large number of components, thus, resulting in an assembly that occupies a large space. Also, such modules may only be compatible with a select range of appliances and modifications are often required to the door-locking modules in order to operably fit with different household appliances. For example, it is often necessary to rearrange the layout of conductive strips and parts within the casing of the module depending on the layout of a particular household appliance for it to work with that appliance. Accordingly, different models of the door-locking module have to be manufactured and assembled, requiring varying production equipment and production lines.

Therefore, it would be desirable to provide an improved door-locking module configured to mitigate the problems associated with the prior art. In particular, it is an object of the present invention to provide a door-locking module adapted to determine the movement and position of a locking pin, that is more compact (compared to other door locking modules) and that has an improved compatibility with different layouts and types of household appliances.

The present invention provides at least an alternative embodiment to door-locking modules of the prior art.

### SUMMARY OF THE INVENTION

In accordance with the present invention there is provided a door-locking module according to the appended claims.

According to an aspect of the present invention, there is provided a door-locking module for a door of a household appliance, comprising:
a housing;
a printed circuit board (PCB), received within the housing and comprising at least one first actuator switch adapted to open and close a predetermined first circuit of the PCB;
a locking pin configured to move between a locked position, affecting the door into a locked state, and an unlocked position, affecting the door into an unlocked state;
an actuator, operably coupled to the locking pin so as to controllably move the locking pin between the unlocked position and the locked position; and
a locking ring, operably coupled between the actuator and the at least one first actuator switch, comprising a trigger member adapted to operably engage with the signal actuator, and at least one cam guide adapted to cooperate with a corresponding cam follower of the locking pin.

Thus, when the trigger member engages with the first actuator switch of the PCB at a predetermined position, a contact or circuit of the PCB is closed or open so that a signal can be generated to indicate the position of the locking member (i.e., locked or unlocked). This is particularly advantageous because PCB components are used directly to indicate the position of the locking pin, thus, allowing the overall size of the door-locking module to be made more compact. Further, the use of PCB mounted switches that are directly engaged by the module component(s) provides for a door-locking module that is more compatible with a wider range of different appliance layouts.

Advantageously, the at least one cam guide comprises an enclosed cam surface.

By having an enclosed cam surface with a defined first stop terminating at a first end and a second stop terminating at a second end, the position of the locking pin is defined between the two positions, which more accurately determines the position of the locking pin.

Advantageously, the enclosed cam surface of the at least one cam guide comprises a first stop terminating at a first end, and a second stop terminating at a second end opposite the first end. Preferably, the locking pin is in the unlocked position when the cam follower engages the first stop, during use. Additionally, the locking pin is in the locked position when the cam follower engages the second stop, during use.

Advantageously, the actuator is configured to move the locking pin bidirectionally between the unlocked position and the locked position.

By providing an actuator in this way, the locking pin can move back and forth between the two positions, which accurately defines the position and the movement of the locking pin within the predefined space.

Advantageously, the actuator is operably coupled to the locking pin via a transmission.

Preferably, the transmission is a gear assembly, comprising a plurality of cooperating gears.

By providing a gear assembly between the actuator and the locking pin, rotational movement is transferred over a predetermined spacing at a desired ratio between the input and the output, i.e., a predetermined rotational movement of the motor results in a desired rotational movement of the locking ring.

Advantageously, the PCB comprises at least one second actuator switch adapted to open and close at least one second predetermined circuit of the PCB.

Preferably, the door-locking module further comprises a sensing member coupled with the door of the appliance and adapted to move between a first position, engaging the second actuator switch, when the door is open, and a second position, disengaged from the second actuator switch, when the door is closed.

Advantageously, the actuator is an electric motor.

Alternatively, the actuator is a piezo-electric actuator. Preferably, the piezo-electric actuator is operably coupled to the locking pin via a sliding member. Optionally, the sliding member is operably coupled to the locking pin via a coupler adapted to translate movement of the sliding member into a desired movement of the locking pin.

### BRIEF DESCRIPTION OF SEVERAL VIEWS OF THE DRAWINGS

Embodiments of the invention are now described, by way of example only, hereinafter with reference to the accompanying drawings, in which:

FIG. 1(a) illustrates a side view of an example embodiment of the door-locking module, with the housing removed;

FIG. 1(b) illustrates a side view of an alternative example embodiment of the door-locking module, with the housing removed;

FIG. 2(a) illustrates a schematic representation showing a top view of an example embodiment of the door-locking module with the printed circuit board and tactile switches attached;

FIG. 2(b) illustrates a schematic representation showing a top view of an example embodiment of the door-locking module with the PCB and tactile switches removed;

FIG. 3(a) illustrates a schematic representation showing a top view of an alternative embodiment of the door-locking module, with the printed circuit board and movable contact blade attached;

FIG. 3(b) illustrates a schematic representation showing a top view of an alternative embodiment of the door-locking module, with the PCB and moveable contact blade removed;

FIG. 4(a) illustrates a close-up detailed perspective view of the locking pin end of the door-locking module with the locking pin in a first position (i.e., towards unlocked);

FIG. 4(b) illustrates a close-up detailed perspective view of the locking pin end of the door-locking module with the locking pin in a second position (i.e. locked position);

FIG. 5(a) illustrates a close-up detailed perspective view of the locking pin end of the alternative door-locking module with the locking pin in a first position (i.e. towards unlocked);

FIG. 5(b) illustrates a close-up detailed perspective view of the locking pin end of the alternative door-locking module with the locking pin in a second position (i.e. locked position);

FIG. 6(a) shows a close-up of the cam-guide of the locking pin with a first and second ramp surface;

FIG. 6(b) shows a close-up of the cam-guide of the locking pin with a single ramp surface;

FIG. 7(a) illustrates a close-up lower perspective view of the locking pin end of the door-locking module with the trigger member of the locking ring disengaged from the first actuator switch (locking pin in the unlocked position);

FIG. 7(b) illustrates a close-up lower perspective view of the locking pin end of the door-locking module with the trigger member of the locking ring switchingly engaged with the first actuator switch (locking pin in the locked position);

FIG. 8(a) illustrates a close-up side view of the locking pin end of the alternative embodiment of the door locking module with the movable contact blade (actuator switch) in contact with a respective PCB circuit (indication a locked state);

FIG. 8(b) illustrates a close-up side view of the locking pin end of the alternative embodiment of the door locking module with the movable contact blade (actuator switch) moved out of contact with the respective PCB circuit (indication an unlocked state);

FIG. 9(a) illustrates a partial top view of the manual actuator and actuator arm in a disengaged position;

FIG. 9(b) illustrates an exploded view of the gear and locking ring coupling including a clutch mechanism;

FIG. 10(a) illustrates a schematic representation showing a partial top view of an example embodiment of the door locking module with the actuator arm of the manual actuator disengaged from the locking ring lever;

FIG. 10(b) illustrates a schematic representation showing a partial top view of an example embodiment of the door locking module with the actuator arm pushed down rotating the locking ring and moving the locking pin back into its unlocked position;

FIG. 11(a) illustrates a schematic representation showing a partial top view of the alternative embodiment of the door locking module with the actuator arm of the manual actuator disengaged from the locking ring lever;

FIG. 11(b) illustrates a schematic representation showing a partial top view of the alternative embodiment of the door locking module with the actuator arm pushed down rotating the locking ring and moving the locking pin back into its unlocked position;

FIG. 12 illustrates yet another alternative example embodiment of the door-locking module utilising a piezo-electric actuator instead of an electric motor described with the example embodiments shown in FIGS. 1 to 11, and

FIG. 13 illustrates a simplified schematic representation of a portion of the door-locking module of FIG. 12, indicating the movement of the plunger or sliding member effected by the piezo-electric actuator.

### DETAILED DESCRIPTION OF THE EMBODIMENTS

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g., central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

Like reference numerals are used to depict like features throughout, i.e., identical reference numerals are used for components identical in different embodiments of the present invention.

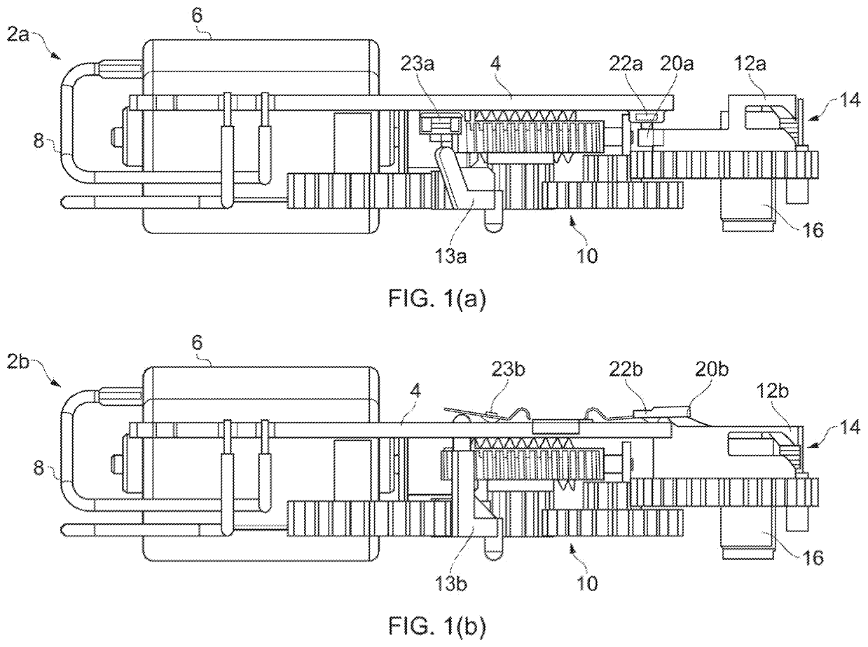

Referring now to FIG. 1, two embodiments of a door-locking module 2a, 2b are illustrated, (a) a door-locking module 2a including printed circuit board 4 (PCB) bottom-mounted first and second actuators or sensors 22a, 23a, respective locking ring 12a and door sensing pin 13a, and (b) a door locking module 2b including PCB 4 top-mounted second actuators or sensors 22b, 23b, respective locking ring 12b and door sensing pin 13b. Each of the two alternative embodiments 2a, 2b includes a PCB 4, an electric motor 6 that is operably connected to the PCB 4 by electric wires 8, and a gear mechanism 10. The electric motor 6 may be a 12V DC motor having an output shaft connected to an extending worm gear shaft 11 operably coupled to the locking ring 12a, 12b (e.g. a cam member) via the gear mechanism 10. The gear mechanism 10 comprises interconnected gears 10a, 10b and 10c. Functionally, the worm gear shaft 11 drives gear 10a coupled with gear 10b, which then drives gear 10c. The gear ratios between the respective engaging gears 10a, 10b, 10c and the worm gear 11 are chosen so that a given motor rotation provides a suitable rotational movement of the locking ring 12a, 12b. The locking ring 12a, 12b includes a cam guide 14 that is provided within a cylindrical wall portion of the locking ring 12a, 12b, as well as, a trigger member 20a, 20b adapted to engage with the respective first actuator or sensor 22a, 22b. In one embodiment of the door locking module 2a, the trigger member 20a is extending radially outward from a portion of the cylindrical wall of the locking ring 12a. In another embodiment of the door locking module 2b, the trigger member 20b comprises a cam surface provided on top of the cylindrical wall of the locking ring 12b.

The door-locking module 2a, 2b further includes a locking pin 16 adapted to engage with the cam guide 14 via a cam follower 18. The locking ring 12a, 12b is operably coupled to and coaxially arranged with the gear 10c, so as to directly transfer rotational movement of the gear 10c into rotational movement of the locking ring 12a, 12b. The rotational movement of the locking ring 12a, 12b and cam guide 14 then translates into a linear movement of the cam follower 18 and locking pin 16 (axial movement). In this particular example, the cam guide 14 is formed by an enclosed aperture within a portion of the cylindrical wall of the locking ring 12a, 12b, extending between a first aperture end and a second aperture end, thus, limiting the rotational movement of the locking ring 12a, 12b and the axial movement of the cam follower 18 to a predetermined range.

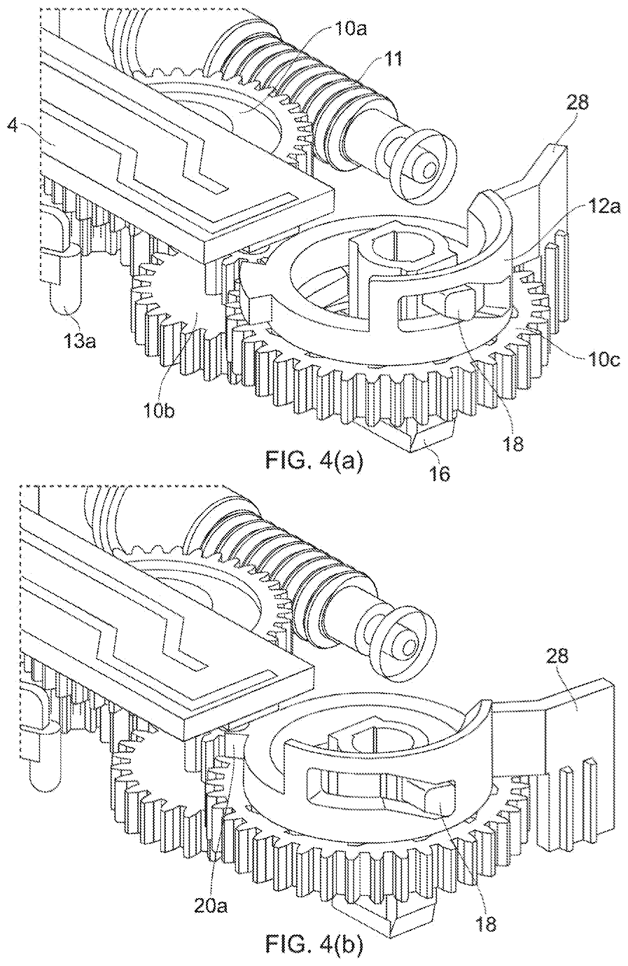

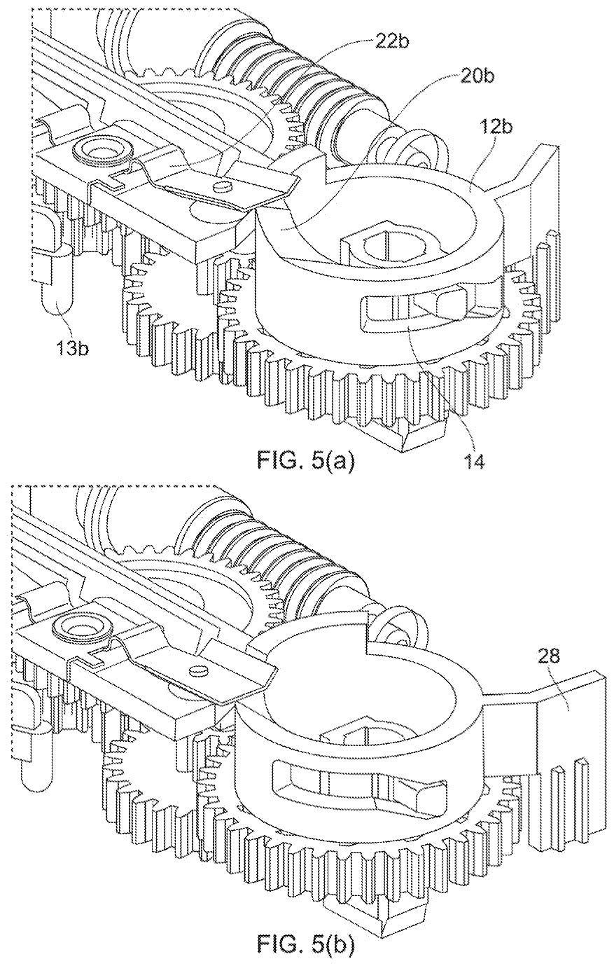

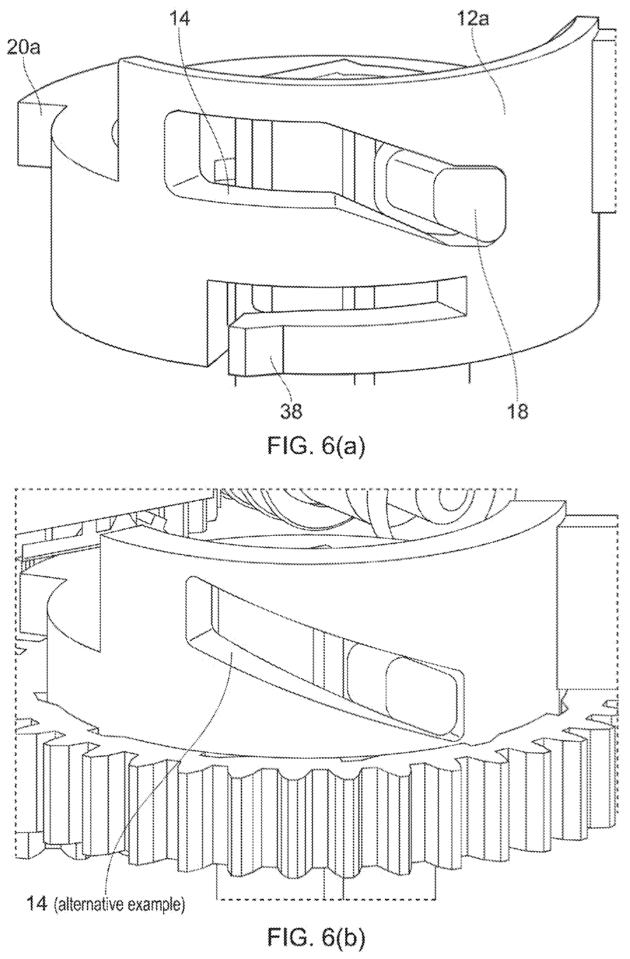

In a preferred embodiment, the cam guide 14 may be formed by an aperture defining a first ramp at a first angle (with respect to the rotational- or centre axis of the locking ring 12a, 12b) followed by a second ramp at a second angle (different from the first angle). For example, the lower portion of the aperture may be at a steeper angle than the following upper portion of the aperture (see, for example, FIGS. 4, 5 and 6(a)). Alternatively, as illustrated for example in FIG. 6(b), the cam guide 14 may be formed by an aperture defining a straight ramp at a predetermined single angle (with respect to the rotational axis of the locking ring 12a, 12b). Furthermore, it is understood by the person skilled in the art that any suitable shape/profile may be used for the aperture within the scope of the present invention, i.e., the cam guide 14 provided by the aperture may have any desired profile.

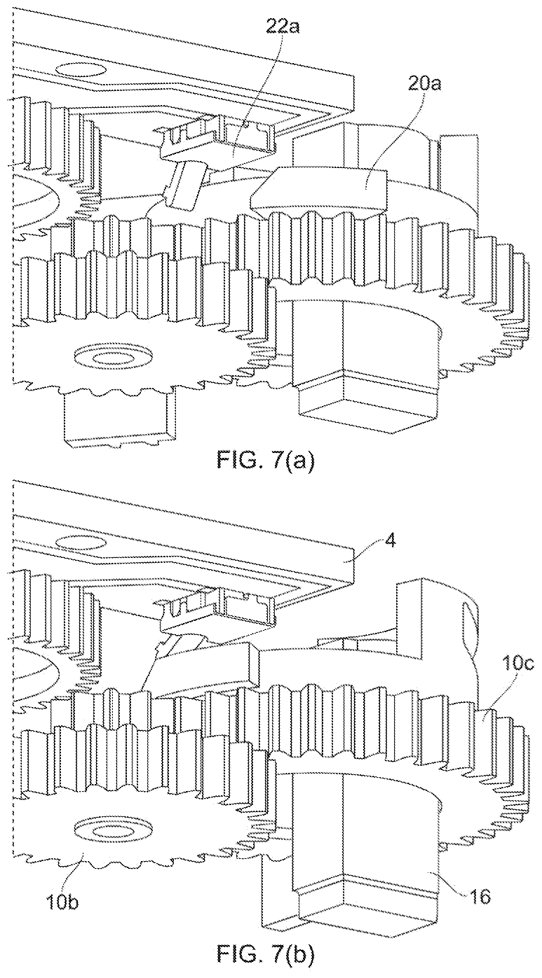

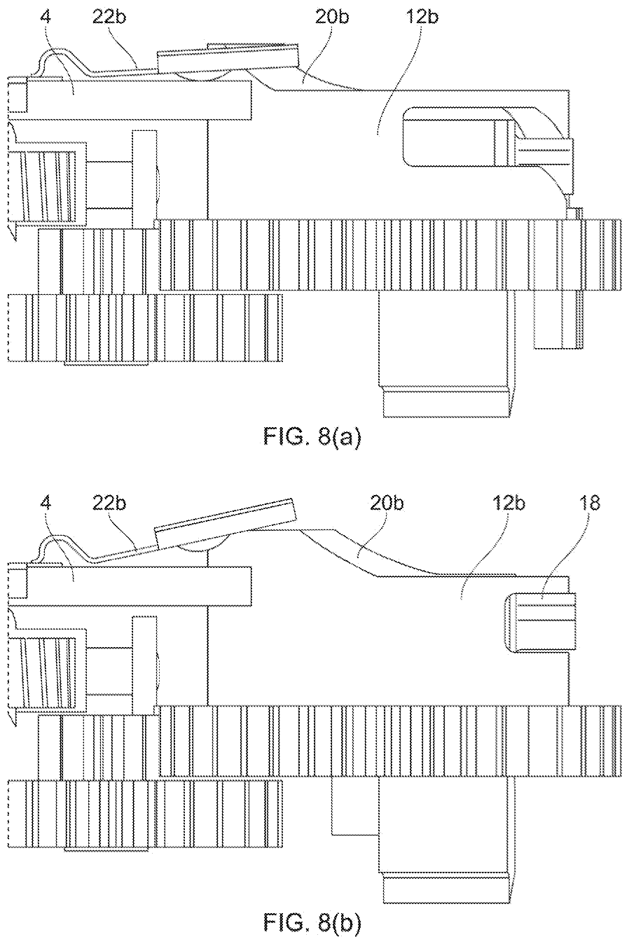

Referring now particularly to the example embodiments shown in FIGS. 1, 7 and 8, the first actuator or sensor 22a, 22b, provided on the printed circuit board 4 (PCB) for cooperation with the trigger member 20a, 20b, may be a detector switch or a movable contact blade, respectively. The second actuator or sensor 23a, 23b may be a tactile switch or a movable contact blade, respectively. During use, the rotation of the locking ring 12a, 12b moves the trigger member 20a, 20b into or out of engagement with the first actuator 22a, 22b at a predetermined rotational position. For the example embodiment using a detector switch (FIG. 7, PCB bottom-mounted with switch lever), the trigger member 20a is a projection extending radially outwards from the locking ring 12a that is adapted to flip the switch lever of the first actuator or sensor 22a. For the alternative embodiment using a movable contact blade 22b (FIG. 8, PCB top-mounted spring contact), the trigger member 20b is a cam-surface on top of the locking ring 12b that is configured to slidingly engage with the moving contact blade (e.g., a resilient metal blade) of the first actuator or sensor 22b. During use, the cam surface on top of the locking ring 12b moves the resilient metal contact between a close-circuit position (FIG. 8(a)) and an open-circuit position (FIG. 8(b)) on the PCB 4. Further, the resilient metal contact (movable contact blade 22b) is biased towards the close-circuit position.

Referring back to FIG. 1, a door sensing pin 13a, 13b is provided between the second actuator or sensor 23a, 23b and the appliance door (e.g., via a linkage or other components engageable by the appliance door). In one embodiment, the door sensing pin 13a, 13b is arranged, so as to allow sliding movement between an engaged position, engaging the second actuator or sensor 23a, 23b (i.e., the bottom-mounted tactile switch, or the top-mounted movable blade contact), and a disengaged position, disengaged from the second actuator or sensor 23a, 23b. For example, when using the tactile switch 23a (FIG. 1(a)), the door sensing pin 13a is configured so as to slidingly move into and out of contact with the tactile switch component when in the engaged position, whereas, when using the movable blade contact 23b (FIG. 1(b)), the door sensing pin 13b is configured, so as to slidingly move the resilient metal contact (i.e. spring contact) from the close-circuit position into the open-circuit position and vice versa. Further, it is understood by the person skilled in the art, that any other suitable door sensing mechanisms may be used. For example, a rotatable lever arm may be provided between the second actuator or sensor (e.g., a lever switch, or an optical switch) and the appliance door that is configured to move into and out of engagement with the second actuator or sensor in accordance with the position of the appliance door (i.e., closed or open).

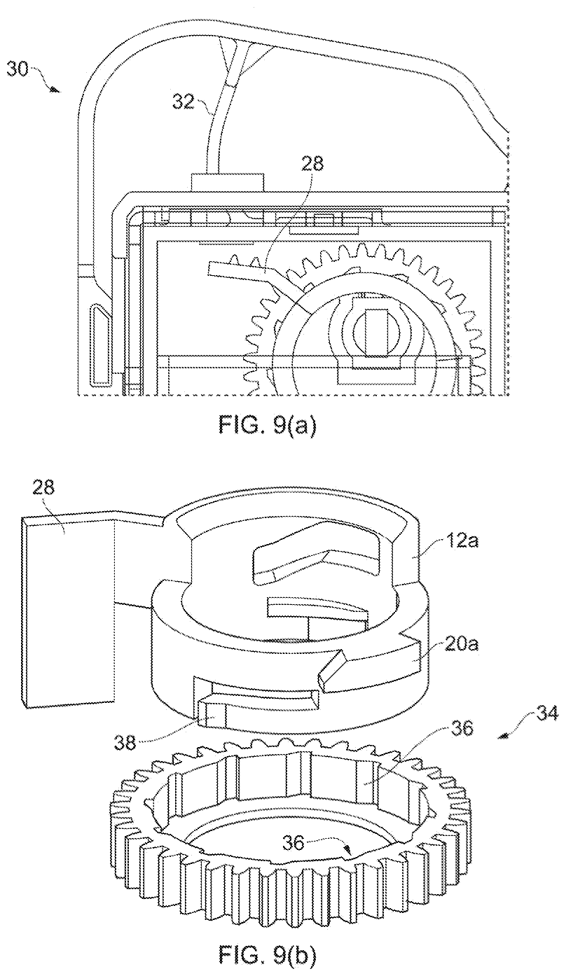

Referring now to the illustration shown particularly in FIG. 9, in the event that the appliance door has to be unlocked manually, a manual actuator 30 is provided to rotate the locking ring 12a, 12b back to its unlocked position (e.g., counterclockwise) via a locking ring lever 28. In order to prevent any damage to the gears 10a, 10b, 10c, 11 when manually rotating the locking ring 12a, 12b back to its unlocked position, a unidirectional clutch mechanism 34 is provided with the coupling between the gear 10c and the coaxially arranged locking ring 12a, 12b. The clutch mechanism 34 comprises a plurality of apertures or cavities 36 that are circumferentially equidistantly arranged on an inner surface of gear 10c (see FIG. 9(b)) and at least two resilient tooth members 38 provided with the cylindrical wall of the locking ring 12a, 12b and arranged, so as to operably engage with the apertures or cavities 36 of gear 10c, i.e. the resilient tooth members 38 can slidably move from one aperture or cavity 36 to another in one direction (e.g. counterclockwise) while the gears remain stationary, but lockingly engage with any one of the apertures or cavities 36 in the opposite direction (e.g. clockwise), thus rotating with the locking ring 12a, 12b.

The door locking module 2 is further provided with a housing 26 adapted to operably accommodate at least the component parts, such as, the PCB 4, motor 6 and wires 8, gear mechanism 10, locking ring 12a, 12b, door sensing pin 13a, 13b and locking pin 16.

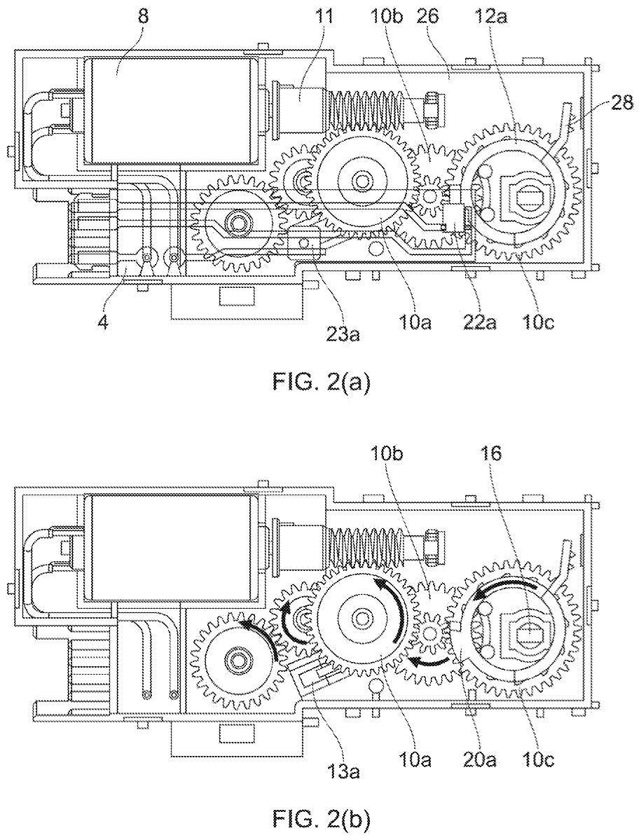

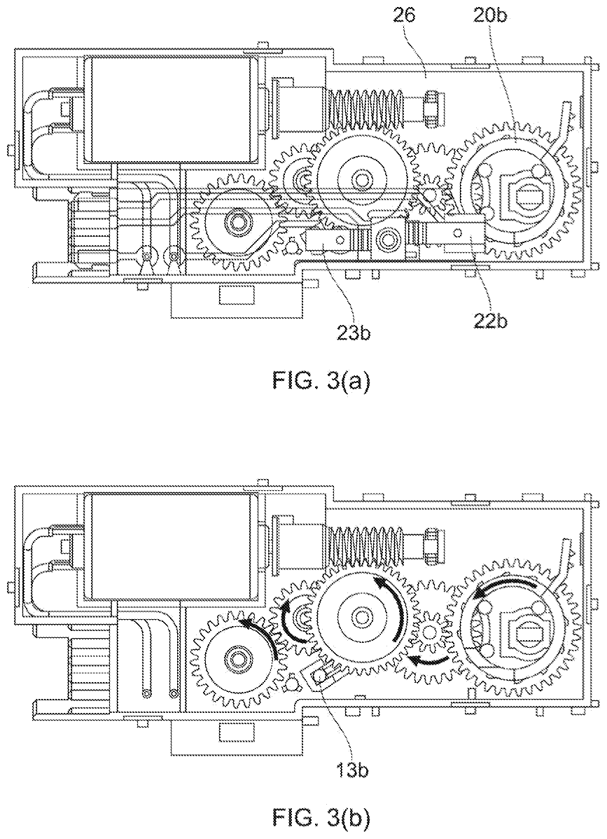

During operation and as illustrated in FIGS. 2(b) and 3(b), the electric motor 6 is actuated or energized so that the output shaft of the electric motor 6 and the attached worm gear shaft 11 rotate in a desired direction. The worm gear 11 engages gear 10a, which in turn engages gear 10b to then engage gear 10c and rotating the locking ring 12a, 12b. In FIGS. 2(b) and 3(b) the directions of rotation are indicated by arrows on respective gears 10a, 10b, 10c. As such, the actuation of the electric motor 6 drives the locking ring 12a, 12b via gear mechanism 10 either clockwise or counterclockwise.

As shown in FIGS. 4, 5 and 6, the rotational motion of the motor 6 is transferred onto the locking ring 12a, 12b via coupled gear 10c. Rotation of the locking ring 12a, 12b changes the position of the cam guide 14 relative to the engaged cam follower 18 of the locking pin 16, thus, axially moving the locking pin 16 between the locked and unlocked position. In particular, when the locking ring 12a, 12b is rotated counterclockwise, the cam follower 18 is positioned at a first end (left end or upper end) of the cam guide 14, causing the locking pin 16 to be moved up (unlocked from the appliance door). When the locking ring 12a, 12b is rotated clockwise, the cam follower 18 is positioned at the second end (right end or lower end) of the cam guide 14, causing the locking pin 16 to be moved down (locking the appliance door). Since the electric motor 6 is drivable bidirectionally (i.e., clockwise and counterclockwise), it is possible to control the position of the locking pin 16 via motor control.

Referring now to FIGS. 7 and 8, the first actuator or sensor 22a, 22b is engaged by the trigger member 20a, 20b, respectively, which generates a signal corresponding to the position of the locking pin 16 and indication the locking state of the appliance door. For example, clockwise rotation of the locking ring 12a, 12b moves the trigger member 20a, 20b into switching engagement with the first actuator or sensor 22a, 22b causing a signal to be generated that indicates the locked position of the appliance door. Counterclockwise rotation of the locking ring 12a, 12b moves the trigger member 20a, 20b out of switching engagement with the first actuator or sensor 22a, 22b causing a signal to be generated that indicates the unlocked position of the appliance door. Further, integrating the actuator or sensor 22a, 22b with the PCB 4, so as to cooperate with the trigger member 20a, 20b, allows the use of PCB's 4 with reduced dimensions (compared to present locking modules), because the position of the locking pin 16 is sensed directly from the position of the locking ring 12a, 12b.

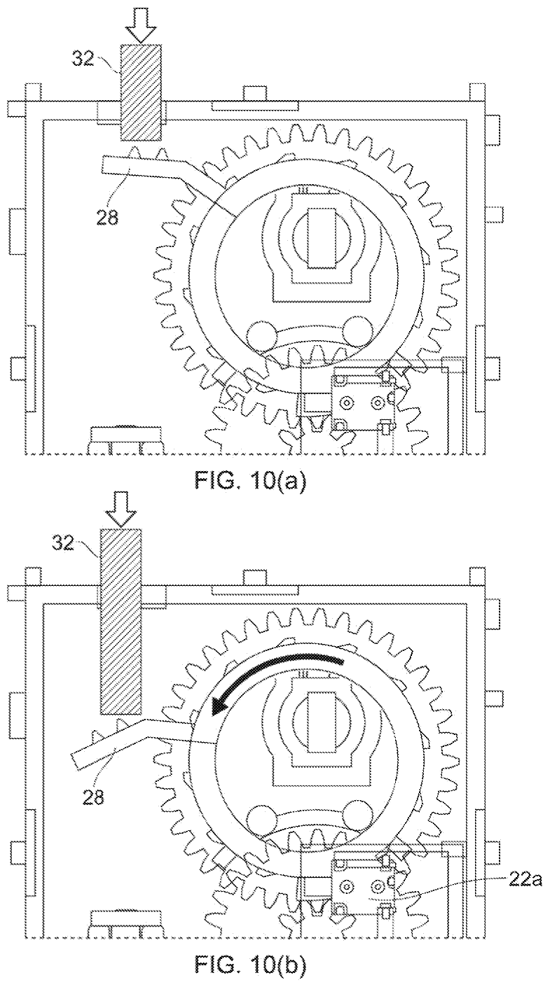

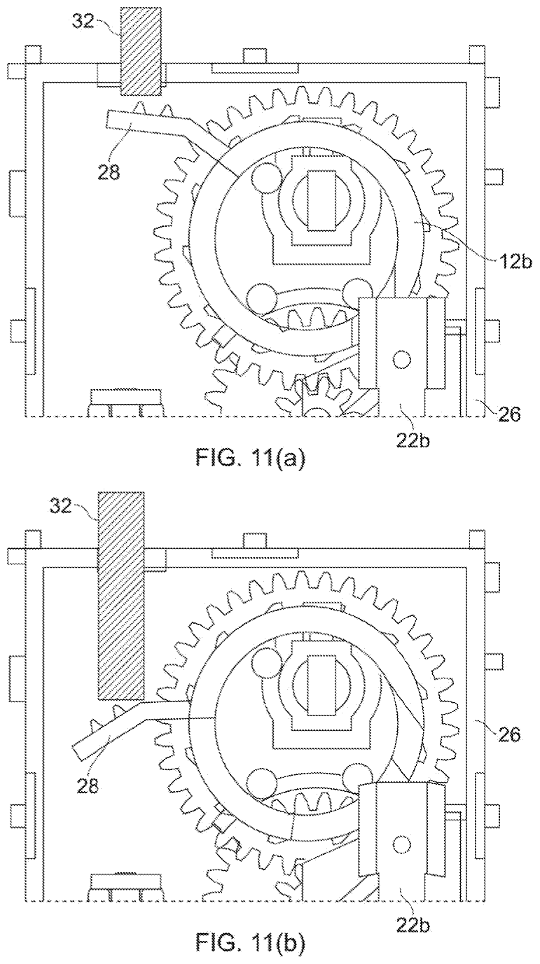

Further, and as illustrated in FIGS. 9, 10 and 11, the clutch mechanism 34 is used to provide a manual unlock function of the appliance door that is decoupled from the gear mechanism 10. Here, the actuator arm 32 of the manual actuator 30 is pushed into engagement with the locking ring lever 28, thus, rotating the locking ring counterclockwise relative to a stationary gear 10c, with the tooth member(s) 38 sliding through the apertures 36. This decoupled rotation of the locking ring 12a, 12b moves the locking pin 16 into the unlocked position. FIG. 10 shows the embodiment with the locking ring 12a having a protrusion as trigger member 20a, and FIG. 11 shows the alternative embodiment with the locking ring 12b having a cam surface on top of the locking ring as trigger member 20b.

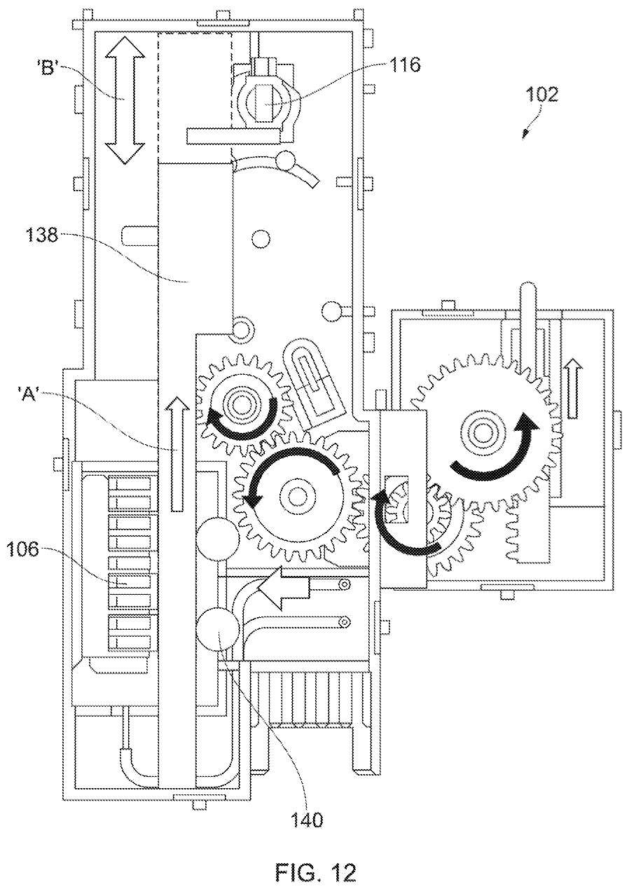

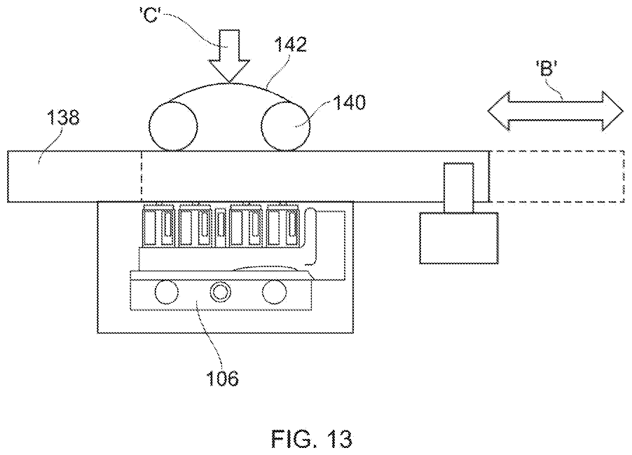

Referring now to FIGS. 12 and 13, another alternative example embodiment of the door-locking module 102 is shown. Here, the electric motor 6 and gear mechanism 10 are simply replaced by a piezo-electric actuator 106 that is configured to move the locking pin 116 between the locked position and the unlocked position, either directly or indirectly. When engaging the locking pin 116 directly, the locking pin 116 may be adapted or configured to move axially when engaged by a moving plunger or sliding member 138 of the piezo-electric actuator 106. When engaging the locking pin 116 indirectly, similar to the previous embodiments of the door locking module 2a, 2b (i.e., via the locking ring 12a, 12b), a coupler (not shown) may be utilized to translate the linear movement of the plunger or sliding member 138 in one direction into a linear movement of the locking pin 116 in a different direction (e.g., perpendicular to the direction of the plunger or sliding member 138). For example, the coupler may be a coupler ring that is similar to the locking ring 12a, 12b having an aperture or cam guide 14 engaging with the locking pin 116 so as to effect the liner movement of locking pin 116. However, it is understood by the person skilled in the art, that any other coupler mechanism suitable to translate the linear movement of the plunger or sliding member 138 in one direction into a sliding movement of the locking pin 116 in another direction may be used.

The principle function of a piezo-electric actuator, such as the one used in the embodiment of the present invention illustrated in FIGS. 12 and 13, is known in the art and, thus, not described in any further detail. In one example, the piezo-electric actuator 106 may be configured to operate at a high frequency (e.g., 2000 Hz) and adapted to provide a pushing load (via the plunger or sliding member 138) suitable to move the locking pin 116 between its locked position and its unlocked position. Also, it is understood by the person skilled in the art, that components described for the example embodiments 2a, 2b as illustrated in FIGS. 1 to 11 and required for the desired function of the door locking module 102 are incorporated by reference to these embodiments and are not described in any further detail.

Using a piezo-electric actuator 106 instead of an electric motor 6 or any other solenoid actuator can considerably reduce the number of components that may be required to drive the locking pin 116, thus, leading to an even more compact door-locking module 102.

In use, the piezo-electric actuator 106 is configured to slidably move the plunger or sliding member 138 in a direction such as denoted by the arrow ‘A’. The plunger or sliding member 138 is adapted to operably engage with the locking pin 116 locking ring so as to move the locking pin 116 between its locked and unlocked position. The plunger or sliding member 138 may be supported by biased bearings 140 using a contrast spring 142, so as to provide a biasing force onto the plunger surface, i.e., exerting a force in a direction such as denoted by arrow ‘C’. The possible stroke of the plunger or sliding member 138 is denoted by the arrow ‘B’. For one possible coupler mechanism between the plunger or sliding member 138 and the locking pin 116, an integrated bias (e.g., spring) may urge the locking pin 116 back into its unlocked position, when the plunger or sliding member 138 is moved back into a rest position (i.e., out of engagement with the locking pin 116). The bidirectional linear movement of the plunger 138 may also be utilized to open and close suitable switches on a PCB (not shown in FIGS. 12 and 13), in order to indicate a particular state (open, closed) of the appliance door.

It is understood by the person skilled in the art that various suitable mechanism can be used to operably couple the movable plunger with the locking pin 116 and respective switches, actuator or sensor on the PCB without diverting from the scope of the present invention.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

It is claimed:

1. A door-locking module for a door of a household appliance, comprising:
a housing;
a printed circuit board (PCB), received within the housing and comprising at least one first actuator switch adapted to open and close a predetermined first circuit of the PCB;
a locking pin configured to move between a locked position, affecting the door into a locked state, and an unlocked position, affecting the door into an unlocked state;
an actuator, operably coupled to the locking pin so as to controllably move the locking pin between the unlocked position and the locked position, and
a locking ring, operably coupled between the actuator and the at least one first actuator switch, comprising a trigger member adapted to operably engage with the signal actuator, and at least one cam guide adapted to cooperate with a corresponding cam follower of the locking pin.

2. The door-locking module according to claim 1, wherein the at least one cam guide comprises an enclosed cam surface.

3. The door-locking module according to claim 2, wherein the enclosed cam surface of the at least one cam guide comprises a first stop terminating at a first end, and a second stop terminating at a second end opposite the first end.

4. The door-locking module according to claim 3, wherein the locking pin is in the unlocked position when the cam follower engages the first stop, during use.

5. The door-locking module according to claim 3, wherein the locking pin is in the locked position when the cam follower engages the second stop.

6. The door-locking module according to claim 1, wherein the actuator is configured to move the locking pin bidirectionally between the unlocked position and the locked position.

7. The door-locking module according to claim 1, wherein the actuator is operably coupled to the locking pin via a transmission.

8. The door-locking module according to claim 7, wherein the transmission is a gear assembly, comprising a plurality of cooperating gears.

9. The door-locking module according to claim 1, wherein the PCB comprises at least one second actuator switch adapted to open and close at least one second predetermined circuit of the PCB.

10. The door-locking module according to claim 9, further comprising a sensing member coupled with the door of the appliance and adapted to move between a first position, engaging the second actuator switch, when the door is open, and a second position, disengaged from the second actuator switch, when the door is closed.

11. The door-locking module according to claim 1, wherein the actuator is an electric motor.

12. The door-locking module according to claim 1, wherein the actuator is a piezo-electric actuator.

13. The door-locking module according to claim 12, wherein the piezo-electric actuator is operably coupled to the locking pin via a sliding member.

14. The door-locking module according to claim 13, wherein the sliding member is operably coupled to the locking pin via a coupler adapted to translate movement of the sliding member into a desired movement of the locking pin.

15. A door-locking module for a door of a household appliance, comprising:
a housing;
a printed circuit board (PCB), received within the housing and comprising at least one first actuator switch adapted to open and close a predetermined first circuit of the PCB;
a locking pin configured to move between a locked position, affecting the door into a locked state, and an unlocked position, affecting the door into an unlocked state;
an actuator, operably coupled to the locking pin so as to controllably move the locking pin between the unlocked position and the locked position, wherein the actuator is configured to move the locking pin bidirectionally between the unlocked position and the locked position; and
a locking ring, operably coupled between the actuator and the at least one first actuator switch, comprising a trigger member adapted to operably engage with the signal actuator, and at least one cam guide adapted to cooperate with a corresponding cam follower of the locking pin, wherein the at least one cam guide comprises an enclosed cam surface with a first stop terminating at a first end, and a second stop terminating at a second end opposite the first end.

16. The door-locking module according to claim 15, wherein the actuator is operably coupled to the locking pin via a transmission, the transmission comprising a plurality of cooperating gears.

17. The door-locking module according to claim 15, wherein the PCB comprises at least one second actuator switch adapted to open and close at least one second predetermined circuit of the PCB.

18. The door-locking module according to claim 17, further comprising a sensing member coupled with the door of the appliance and adapted to move between a first position, engaging the second actuator switch, when the door is open, and a second position, disengaged from the second actuator switch, when the door is closed.

19. A door-locking module according to claim 15, wherein the actuator is an electric motor.
